(19) United States
(12) Patent Application Publication
(10) Pub. No.: US 2010/0295740 A1
(43) Pub. Date: Nov. 25, 2010

(54) ANTENNA DEVICE AND WIRELESS COMMUNICATION DEVICE

(75) Inventor: Kouji SOEKAWA, Kawasaki (JP)

Correspondence Address: Fujitsu Patent Center;Fujitsu Management Services of America, Inc., 2318 Mill Road, Suite 1010, Alexandria, VA, 22314, US

(73) Assignee: FUJITSU LIMITED, Kawasaki-shi (JP)

(21) Appl. No.: 12/779,628

(22) Filed: May 13, 2010

(30) Foreign Application Priority Data
May 22, 2009 (JP) 2009-124472

(51) Int. Cl. H01Q 9/04; H01Q 1/24

(52) U.S. Cl. 343/702; 343/700 MS

(57) ABSTRACT

An antenna device for use in a wireless communication device includes: a linear antenna element; a feeding portion including first and second feed terminals arranged apart face-to-face; a linear branch element which branches off from the linear antenna element at an intermediate position of the linear antenna element; and a ground conductor connected to an end of the linear branch element. The first feed terminal is connected to an end of the linear antenna element, and the second feed terminal is connected to a power supply unit. Alternatively, the antenna device may be provided with a capacitor which connects an end of the linear antenna element and a connection line connected to the power supply unit.

### CROSS-REFERENCE TO RELATED APPLICATION

This application is based upon and claims the benefit of priority of the prior Japanese Patent Application No. 2009-124472, filed on May 22, 2009, the entire contents of which are incorporated herein by reference.

### FIELD

The embodiments discussed herein are related to an antenna device and a wireless communication device having the antenna device.

### BACKGROUND

Currently, in the field of the wireless communication device such as mobile terminals, the trend toward the multiband arrangement, such as the dual-band or tri-band arrangement is growing. In the wireless communication devices having the multiband arrangement, communication is performed through a plurality of frequency bands (e.g., two frequency bands in the dual-band wireless communication devices, and three frequency bands in the tri-band wireless communication devices). Therefore, various antenna structures corresponding to the multiband arrangement have been developed for antenna devices which are built in wireless communication devices. Among others, a small-sized antenna structure corresponding to a multiband arrangement has been proposed for an antenna device used in a mobile terminal.

FIG. 11 illustrates an example of a structure of an antenna device 100 for use in a mobile terminal having a multiband arrangement. The antenna device 100 uses frequencies 1 and 2 as transmission frequencies. In the following explanations, the wavelength corresponding to the frequency 1 is denoted by λ₁, and the wavelength corresponding to the frequency 2 is denoted by λ₂. The antenna device 100 includes a linear antenna element 102 as a monopole antenna, a linear antenna element 104 as a monopole antenna, a dielectric substrate 106, and a ground conductor 108 arranged on a surface of the dielectric substrate 106. The linear antenna element 102 has the antenna length of λ₁/4, and the linear antenna element 104 has the antenna length of λ₂/4. Since the monopole antennas are used together with the ground conductor 108, it is possible to suppress the gain lowering although the size of the antenna device is small.

Although the monopole antenna usually has a straight form extended away from the ground conductor, each of the linear antenna elements 102 and 104 has an L-shaped form for being built in a limited space in a chassis of a mobile terminal or the like. The common end point of the linear antenna elements 102 and 104 is a feed point 110, and electric power is supplied through a feeder 112, which is connected to a power-supply unit (not shown). The portions 102a and 102b of the linear antenna elements 102 and 104 are arranged to stand on the surface of the ground conductor 108 so that the tips of the portions 102a and 102b are located away from the surface of the ground conductor 108. Two resonances occur in the linear antenna elements 102 and 104 for multiband communication in the antenna device 100 illustrated in FIG. 11.

However, since the two linear antenna elements 102 and 104 are arranged close to each other in the antenna device 100 illustrated in FIG. 11, the antenna device cannot achieve satisfactory characteristics in some cases where the frequencies at which resonances occur are close to each other. FIG. 12 indicates the VSWR (voltage standing wave ratio) of the antenna device 100. The antenna device 100 operates in resonance modes in which the linear antenna element 102 resonates as a monopole antenna at the frequency 1, and the linear antenna element 104 resonates as a monopole antenna at the frequency 2. Specifically, each of the linear antenna elements 102 and 104 operates in a resonance mode in which a quarter of one of the resonant wavelengths of the radio wave is approximately equal to the length of the linear antenna element. In addition, since the linear antenna elements 102 and 104 are arranged close to each other in the limited space in the chassis, the resonances interfere with each other. Therefore, the VSWR value at the frequency 2 cannot become three or smaller, so that it is impossible to supply sufficient electric power to the linear antenna element 104. Further, the above interference reduces the width of the range in which the VSWR is at the bottom level and the bandwidth which can be used in communication.

Furthermore, in a known antenna device for a multiresonant inverted-F-shaped antenna, the antenna characteristics can be adjusted after fabrication (Japanese Laid-open Patent Publication No. 2005-252480). However, this antenna device has antenna elements which operate in resonance modes of monopole antennas. In addition, the antenna elements are closely arranged. Therefore, two resonances interfere with each other in the case where the frequency bands in which the antenna elements resonate are close to each other, so that it is difficult for the antenna device to achieve satisfactory characteristics.

### SUMMARY

According to a first aspect of the invention, an antenna device includes: a linear antenna element; a feeding portion having a first feed terminal and a second feed terminal which are arranged apart face-to-face, where the first feed terminal is connected to an end of the linear antenna element, and the second feed terminal is connected to a power supply unit; a linear branch element which branches off from the linear antenna element at an intermediate position of the linear antenna element; and a ground conductor which is connected to an end of the linear branch element.

According to a second aspect of the invention, an antenna device includes: a linear antenna element; a feeding portion having a capacitor which connects an end of the linear antenna element and a connection line connected to a power supply unit; a linear branch element which branches off from the linear antenna element at an intermediate position of the linear antenna element; and a ground conductor which is connected to an end of the linear branch element.

According to a third aspect of the invention, an wireless communication device includes: the antenna devices according to the first or second aspect of the invention; and a communication unit which performs at least one of generation of waves to be transmitted in a plurality of frequency bands and detection of a plurality of frequency bands.

The objects and advantages of the invention will be realized and attained by means of the elements and combinations particularly pointed out in the claims.

It is to be understood that both the forgoing general description and the following detailed description are exemplary and explanatory and are not restrictive of the invention, as claimed.

### BRIEF DESCRIPTION OF DRAWINGS

Referring now to the attached drawings which form a part of this original disclosure:

FIG. 1 is a diagram illustrating an outline of an antenna device according to a first embodiment;

FIG. 2 is a schematic diagram illustrating an outline of a wireless communication device according to a second embodiment;

FIG. 3 is a schematic diagram illustrating the construction of an antenna device used in the wireless communication device illustrated in FIG. 2;

FIG. 4 is a cross-sectional view illustrating the structures of the first and the second feed terminals in the antenna device illustrated in FIG. 3;

FIG. 5 is a diagram illustrating an antenna body used in the antenna device illustrated in FIG. 3;

FIG. 6 is a diagram illustrating an antenna device different from the antenna device illustrated in FIG. 3;

FIGS. 7A to 7D are diagrams illustrating an antenna device according to a third embodiment;

FIG. 8 is a diagram indicating the VSWR of the antenna device according to the third embodiment;

FIG. 9A is a diagram illustrating an antenna device according to a fourth embodiment;

FIG. 9B is a diagram indicating the VSWR of the antenna device according to the fourth embodiment;

FIG. 10A is a diagrams illustrating an antenna device according to a fifth embodiment;

FIG. 10B is a diagram indicating the VSWR of the antenna device according to the fifth embodiment;

FIG. 11 is a diagram illustrating a conventional antenna device; and

FIG. 12 is a diagram indicating the VSWR of the antenna device illustrated in FIG. 11.

### DESCRIPTION OF EMBODIMENTS

Hereinbelow, the embodiments of the antenna devices and the wireless communication devices are explained in detail.

### First Embodiment

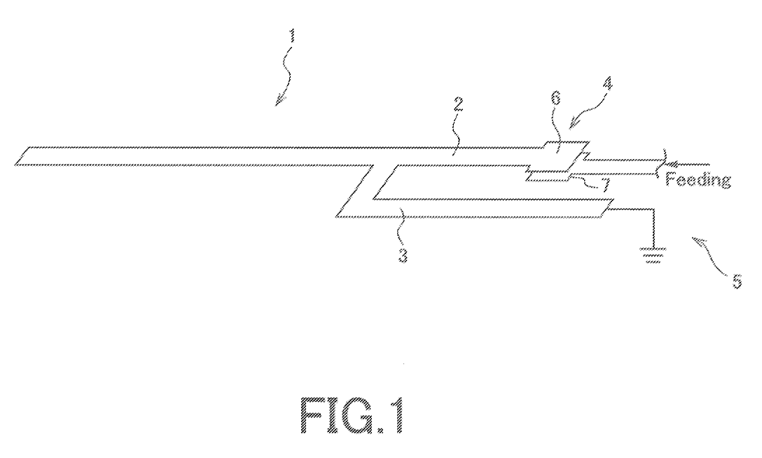

FIG. 1 illustrates an outline of the antenna device 1 according to the first embodiment. The antenna device 1 has a dual-band arrangement and resonates at the frequencies 1 and 2. The antenna device 1 includes a linear antenna element 2, a linear branch element 3, a feeding portion 4, and a ground conductor 5.

The linear antenna element 2 is an antenna element which linearly extends from the feeding portion 4. The linear antenna element 2 has the function of a monopole antenna which resonates at a frequency of a radio wave where a quarter of the wavelength of the radio wave is approximately equal to the length of the linear antenna element 2. The linear branch element 3 is an antenna element which branches off from the linear antenna element 2 at an intermediate position of the linear antenna element 2. The feeding portion 4 has a first feed terminal 6 and a second feed terminal 7 which are arranged apart face-to-face, where the first feed terminal 6 is connected to an end of the linear antenna element 2, and the second feed terminal 7 is connected to a power supply unit. The ground conductor 5 is connected to an end of the linear branch element 3. The linear branch element 3 and the base portion of the linear antenna element 2 which extends from the end of the linear antenna element 2 to the position of the branch produce an inductance component. In addition, the first feed terminal 6 and the second feed terminal 7 which are arranged apart face-to-face produce a capacitance component. Therefore, an LC resonance occurs in the antenna device 1, where the resonance frequency is determined by the inductance component and the capacitance component.

As described above, a resonance occurring in the antenna device 1 is different from the resonance occurring in the linear antenna element 2, so that the two resonances do not interfere with each other. Therefore, the VSWR characteristics can be improved. As explained later, the linear antenna element 2, the linear branch element 3, and the feeding portion 4 in the antenna device 1 may be used in various embodiments.

### Second Embodiment

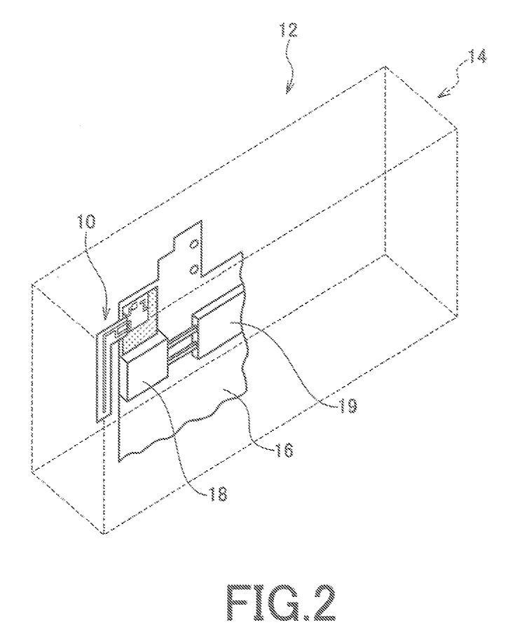

FIG. 2 illustrates an outline of a mobile phone 12 as a wireless communication device according to the second embodiment, where the mobile phone 12 includes an antenna device 10, and the antenna device 10 includes an antenna for a dual-band arrangement corresponding to two frequency bands.

A circuit board 16, together with antenna elements of the antenna device 10, is built in a chassis 14 of the mobile phone 12. The antenna device 10 is produced by using a flexible circuit board. One or more connectors 18 are arranged in the circuit board 16 for connection with the antenna elements in the antenna device 10, so that the circuit board 16 is connected to the antenna elements in the antenna device 10. In addition, the circuit board 16 contains a communication circuit 19 which performs generation of waves to be transmitted in the two frequency bands and detection of received waves in the two frequency bands.

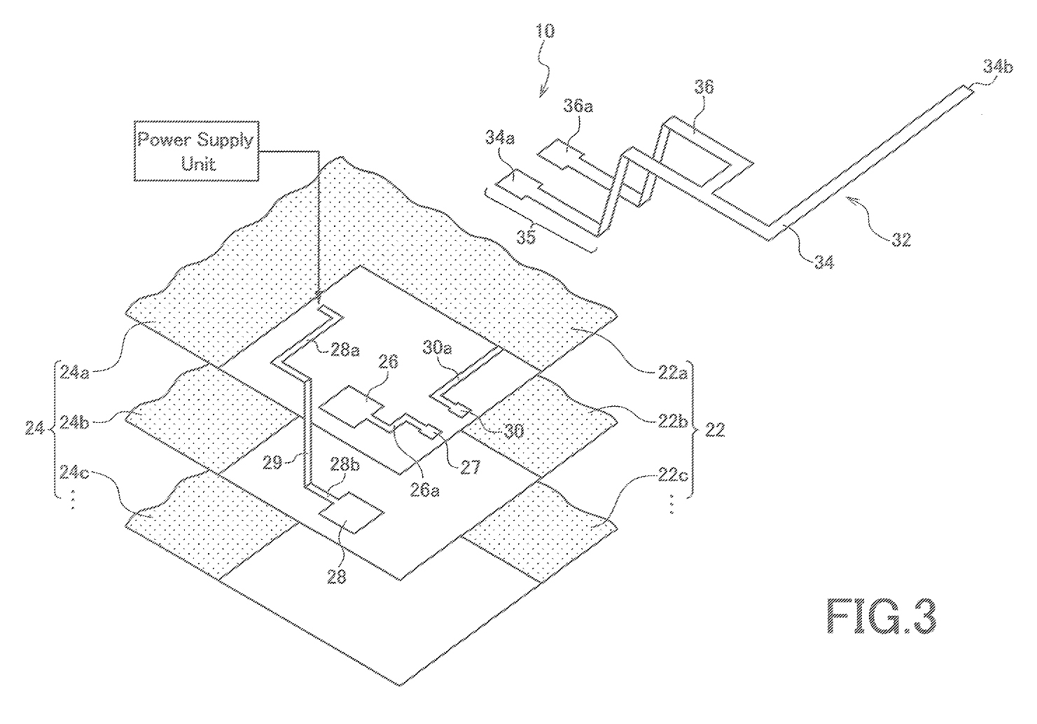

FIG. 3 schematically illustrates the construction of a portion of the circuit board 16 in a vicinity of an antenna feeding portion. The circuit board 16 includes a dielectric substrate 22, a ground conductor 24, a first feed terminal 26, a second feed terminal 28, and a ground terminal (connector mount land) 30. Although the circuit board 16 is a multilayer circuit board, only three layers are illustrated in FIG. 3 for explanation.

A ground conductor 24a, the first feed terminal 26, the ground terminal 30, a feed line 26a, a ground line 30a, a via conductor 29, and a feed line 28a are arranged in the surface layer 22a of the dielectric substrate 22. The feed line 26a connects the first feed terminal 26 and an antenna connection terminal (connector mount land) 27 which will be explained later, the ground line 30a connects the ground terminal 30 and the ground conductor 24a, and the feed line 28a connects the power supply unit and the via conductor 29. A ground conductor 24b, the second feed terminal 28, and a feed line 28b are arranged in the inner layer 22b, which is formed in contact with the surface layer 22a in the dielectric substrate 22. In addition, a ground conductor 24c is arranged in the inner layer 22c, which is formed under and in contact with the inner layer 22b in the dielectric substrate 22.

The ground conductors 24a, 24b, and 24c constituting the ground conductor 24 do not extend to near-corner portions of the layers 22a, 22b, and 22c constituting the dielectric substrate 22, so that the near-corner portion of the surface layer 22a of the dielectric substrate 22 are exposed. The first feed terminal 26, the second feed terminal 28, the ground terminal 30, various lines, and other terminals are arranged in the exposed near-corner portion. The ground terminal 30 is arranged in the vicinity of the first feed terminal 26.

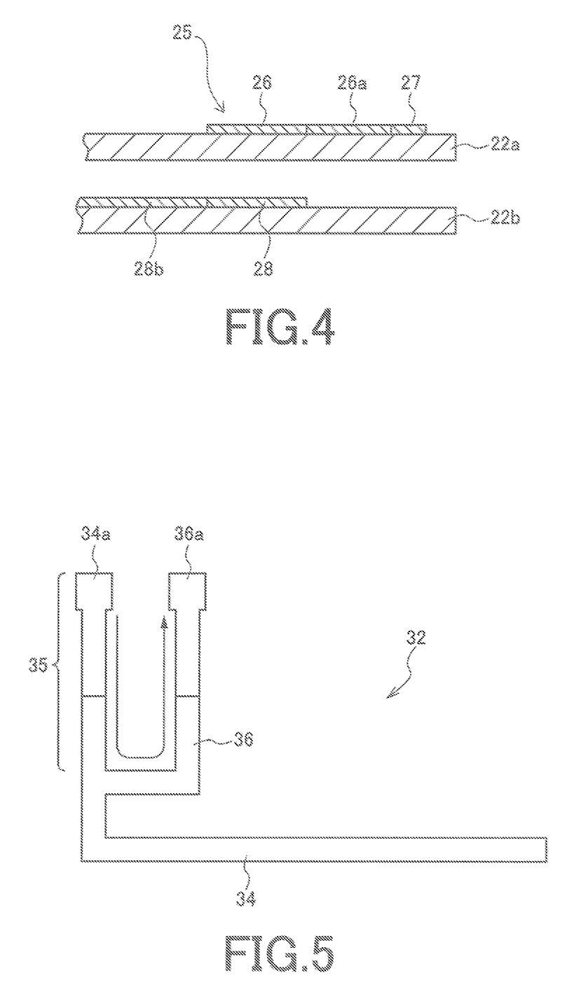

As illustrated in FIG. 4, the first and the second feed terminals 26 and 28 are arranged to sandwich a portion of the surface layer 22a so that the first and the second feed terminals 26 and 28 are positioned apart from each other and face-to face, and constitute the feeding portion 25. The first feed terminal 26 is connected to a linear antenna element 34 through the feed (connection) line 26a and a connector (not shown) mounted on the antenna connection terminal (connector mount land) 27.

The first feed terminal 26 is arranged on the surface layer 22a of the dielectric substrate 22, and the second feed terminal 28 is arranged on the inner layer 22b of the dielectric substrate 22. Therefore, the feed line 28a extending from the power supply unit is connected to the second feed terminal 28 through the via conductor 29.

As illustrated in FIGS. 3 and 5, the antenna body 32 includes the linear antenna element 34 and a linear branch element 36. The linear antenna element 34 operates as a monopole antenna, and the linear branch element 36 branches off from the linear antenna element 34 at an intermediate position of the linear antenna element 34. The linear branch element 36 is arranged to branch off from the intermediate position of the linear antenna element 34 to extend in the direction perpendicular to the extending direction of the linear antenna element 34, and to bend 90 degrees at an intermediate position of the linear branch element 36 to extend in the direction parallel to the base portion 35 of the linear antenna element 34.

The end 34a of the linear antenna element 34 is connected to the antenna connection terminal (connector mount land) 27 through the aforementioned connector (not shown), and the end 36a of the linear branch element 36 is connected to the ground terminal (connector mount land) 30 through a connector (not shown).

The linear antenna element 34 extends on the surface of the dielectric substrate 22 in the direction toward the outside of the dielectric substrate 22, and bends 90 degrees at a first intermediate position of the linear antenna element 34 to extend in a first direction perpendicular to the surface of the dielectric substrate 22 so that the portion of the linear antenna element 34 beyond the first intermediate position stands on the surface of the dielectric substrate 22. Further, the linear antenna element 34 bends 90 degrees at a second intermediate position of the linear antenna element 34 to extend in a second direction parallel to the surface of the dielectric substrate 22, and further bends 90 degrees at a third intermediate position of the linear antenna element 34 to extend in a third direction perpendicular to the second direction and parallel to a side edge of the dielectric substrate 22, so that the portion of the linear antenna element 34 beyond the third intermediate position extends at an elevation identical to the elevation of the portion of the linear antenna element 34 between the second and third intermediate positions and on the different level from the surface of the dielectric substrate 22. The length from the first feed terminal 26 through the end 34a of the linear antenna element 34 to the opposite end 34b of the linear antenna element 34 is approximately λ₁/4, so that a resonance at the frequency 1 occurs, where λ₁ denotes the propagation wavelength of the radio wave in the air corresponding to the frequency 1.

The linear branch element 36 branches off from the aforementioned intermediate position of the linear antenna element 34, and the end 36a of the linear branch element 36 is connected to the ground terminal 30, which is arranged in the vicinity of the first feed terminal 26. As explained before, the first and the second feed terminals 26 and 28 and the surface layer 22a serve as a capacitor, since, the first and the second feed terminals 26 and 28 are arranged apart face-to-face, and the surface layer 22a of the dielectric substrate 22 as a dielectric is sandwiched by the first and the second feed terminals 26 and 28. In addition, a path formed of the linear branch element 36 and the base portion 35 of the linear antenna element 34 serve as an inductor. That is, the linear branch element 36 is arranged parallel to the base portion 35 of the linear antenna element 34, which extends from the end 34a to the position from which the linear branch element 36 branches off. Therefore, a looped current path or a U-shaped current path, as indicated by the curve arrow in FIG. 5, is formed. Thus, the inductor and the capacitor cause an LC resonance at the target frequency 2. The resonance frequency can be adjusted to the target frequency 2 by changing the capacitance component and/or the inductance component. The capacitance component can be changed by changing the amount of the gap between the first and the second feed terminals 26 and 28, or by changing the relative permittivity of the dielectric material sandwiched between the first and the second feed terminals 26 and 28. In addition, the inductance component can be changed by changing the length of the base portion 35 of the linear antenna element 34 or the length of the linear branch element 36.

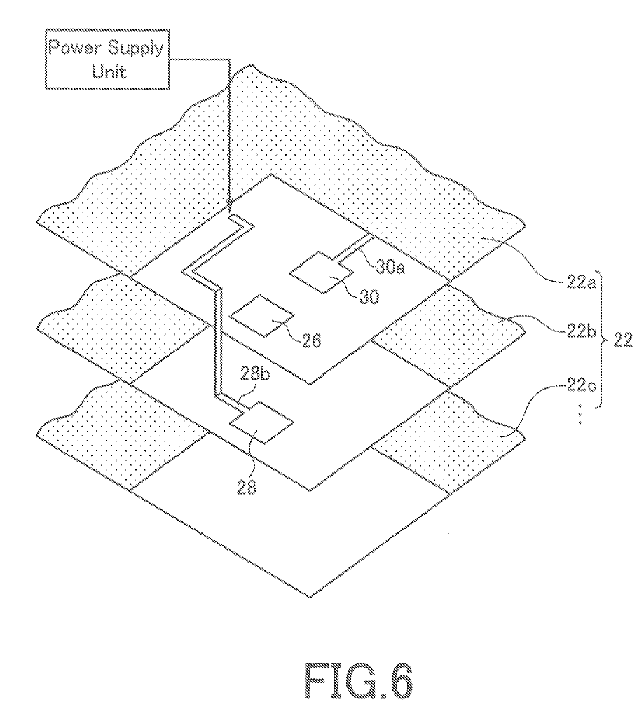

FIG. 6 illustrates another antenna device in which an antenna feed terminal also has the function of the antenna connection terminal. In the antenna device of FIG. 6, the first feed terminal 26 serves as the antenna feed terminal and the antenna connection terminal, and a spring member is mounted on the first feed terminal 26, and connected to the antenna body 32. Alternatively, the antenna body 32 per se may be produced from a springy plate, and be directly connected to the first feed terminal 26 by pressing the antenna body 32 against the first feed terminal 26.

As explained above, the resonance at the frequency 1 occurs in the linear antenna element 34, and the resonance at the frequency 2 occurs since the linear branch element 36 is arranged in addition to the linear antenna element 34. At this time, the resonance at the frequency 1 occurs in a mode in which the linear antenna element 34 operates as a monopole antenna, and the resonance at the frequency 2 occurs in an LC resonance mode due to a capacitor component and an inductance component. As mentioned before, the capacitor component is set up when the first and the second feed terminals 26 and 28 serve as a capacitor, and the inductance component is set up when the base portion 35 of the linear antenna element 34 and the linear branch element 36 serve as an inductor. Since the resonance at the frequency 1 and the resonance at the frequency 2 occur in the respectively different modes, the resonances do not interfere. Thus, it is possible to achieve satisfactory VSWR characteristics.

Hereinbelow, antenna devices according to other embodiments and the VSWR characteristics of the embodiments are explained.

### Third Embodiment

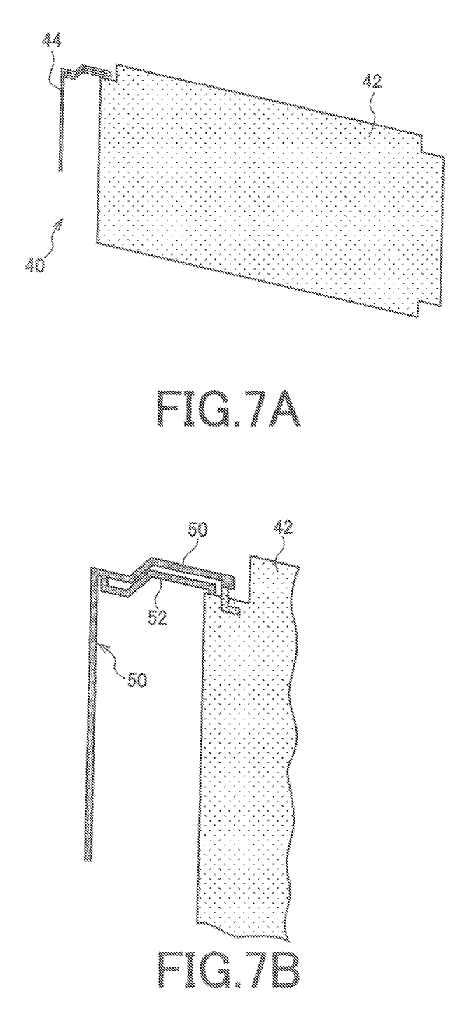

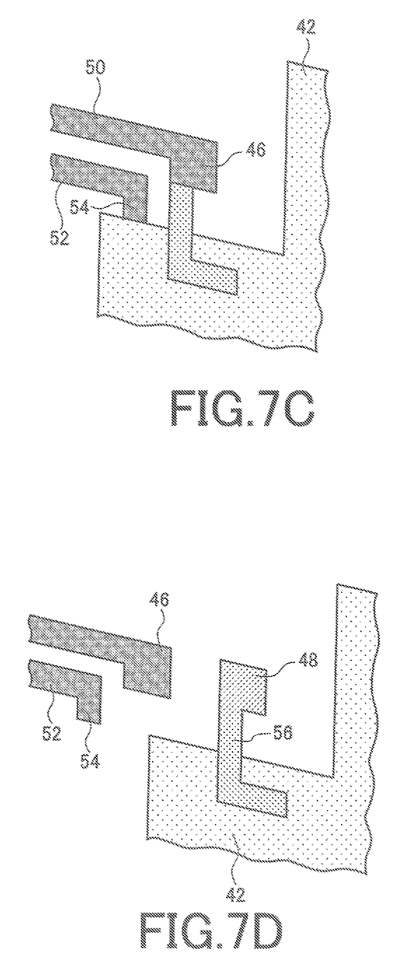

FIGS. 7A to 7D illustrate the antenna device 40 according to the third embodiment. Specifically, FIG. 7A is a perspective view of the entire antenna device 40, FIG. 7B is a magnified view of a portion of the antenna device 40 including a linear antenna element 50 and a linear branch element 52, and FIGS. 7C and 7D are magnified views of a near-corner portion of the antenna device 40. In FIG. 7D, the position of an antenna body 44 is laterally shifted for illustration of a feed line 56.

Similar to the antenna body 32 illustrated in FIG. 3, the antenna body 44 includes the linear antenna element 50 and the linear branch element 52. The linear antenna element 50, as illustrated in FIG. 7B, operates as a monopole antenna, and the linear branch element 52, as illustrated in FIG. 7B, branches off from the linear antenna element 50 at an intermediate position of the linear antenna element 50. A first feed terminal 46 is connected to an end of the linear antenna element 50, and an end 54 of the linear branch element 52 is connected to a ground conductor 42, as illustrated in FIG. 7C. In the embodiment, an approximately looped path from the first feed terminal 46 to the end 54 of the linear branch element 52 through the linear antenna element 50 and the linear branch element 52 is formed.

The first feed terminal 46, which is connected to the end of the linear antenna element 50, is arranged apart from a second feed terminal 48 and face-to face with the second feed terminal 48 through a dielectric substrate (not shown). The second feed terminal 48 is located at an end of a feed line 56. Electric power is supplied from a power supply unit (not shown) through the feed line 56 to the antenna body 44.

In the antenna device 40, similar to the antenna device 10, a first resonance at the frequency 1 occurs in the linear antenna element 50, which operates as a monopole antenna. In addition, a second resonance at the frequency 2 occurs in the arrangement including the structure of the first and the second feed terminals 46 and 48 facing each other via the dielectric substrate and the structure constituted by the base portion of the linear antenna element 50 and the linear branch element 52. The second resonance is an LC resonance due to a capacitor component and an inductance component. The capacitor component is set up when the first and the second feed terminals 46 and 48 serve as a capacitor, and the inductance component is set up when the base portion of the linear antenna element 50 and the linear branch element 52 serve as an inductor. Similar to the antenna device 10, the first resonance at the frequency 1 and the second resonance at the frequency 2 also occur in the respectively different modes in the antenna device 40, so that the first and second resonances do not interfere. Thus, it is possible to achieve satisfactory VSWR characteristics.

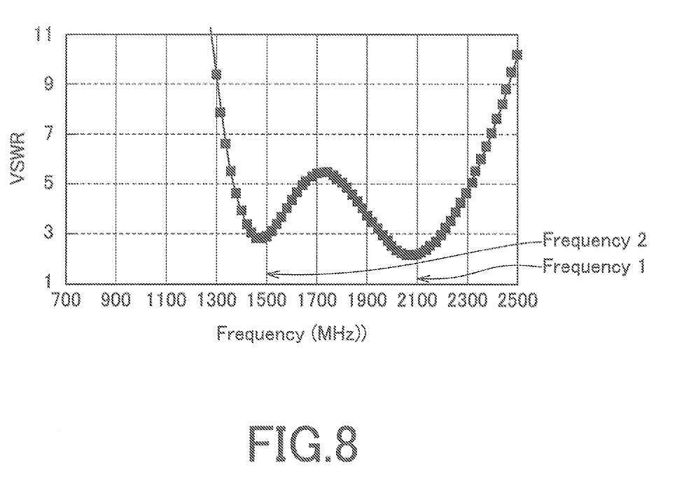

FIG. 8 indicates the VSWR of the antenna device 40 according to the third embodiment. As indicated in FIG. 8, the VSWR of the antenna device 40 in the resonance at the frequency 2 is three or smaller. The width of the bottom range in which the VSWR of the antenna device 40 in the resonance around the frequency 1 is at the bottom level is greater than the width of the bottom range in which the VSWR, indicated in FIG. 12, of the conventional antenna device 100 in the resonance around the frequency 1 is at the bottom level. The bottom range is, for example, the range in which the VSWR is three or smaller. In addition, while the VSWR of the conventional antenna device 100 is, as indicated in FIG. 12, greater than 11 in the range between the frequencies 1 and 2, the VSWR of the antenna device 40 indicated in FIG. 8 is smaller than seven in the range between the frequencies 1 and 2. That is, the interference of the resonances is weak in the antenna device 40, so that the antenna device 40 performs satisfactory characteristics.

### Fourth Embodiment

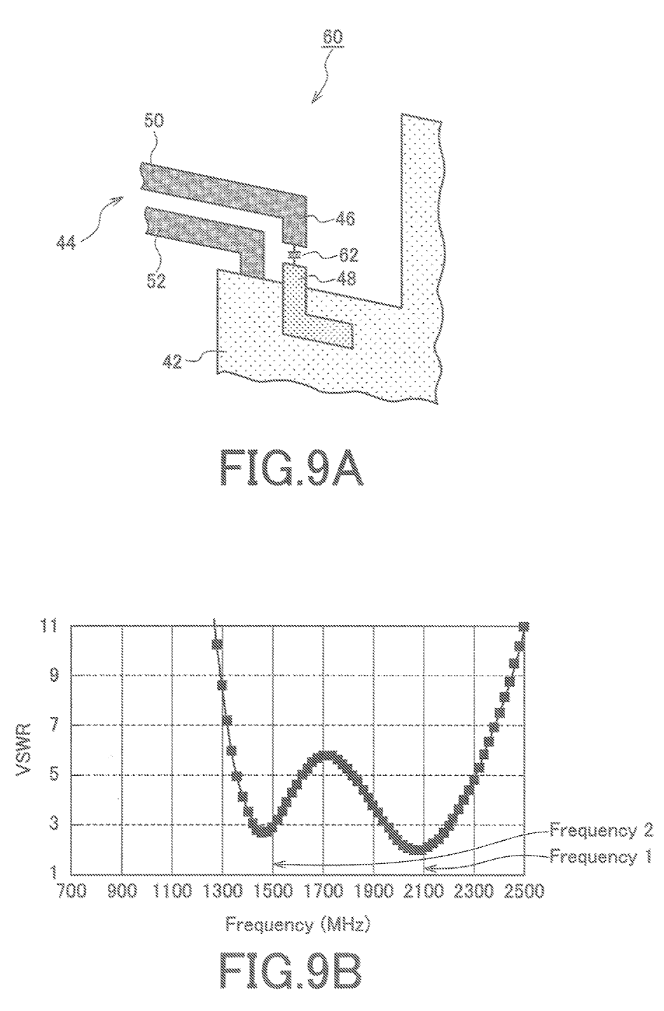

FIG. 9A illustrates the antenna device 60 according to the fourth embodiment. Similar to the antenna body 44 in the antenna device 40 illustrated in FIG. 7B, the antenna body 44 in the antenna device 60 includes a linear antenna element 50 and a linear branch element 52. The linear antenna element 50 operates as a monopole antenna, and the linear branch element 52 branches off from the linear antenna element 50 at an intermediate position of the linear antenna element 50. An end of the linear branch element 52 is connected to a ground conductor 42.

The antenna device 60 is different from the antenna device 40 illustrated in FIG. 7C in the following point. That is, the antenna device 60 is provided with a capacitor 62 between the first and the second feed terminals 46 and 48 which face each other in the antenna device 60, while a portion of the dielectric substrate is sandwiched between the first and the second feed terminals 46 and 48 in the antenna device 40.

In the antenna device 60, similar to the antenna device 10, a first resonance at the frequency 1 occurs in the linear antenna element 50 which operates as a monopole antenna, and a second resonance at the frequency 2 is caused by the capacitor 62 and the structure constituted by a base portion of the linear antenna element 50 and the linear branch element 52. At this time, the first resonance at the frequency 1 occurs in a mode in which the linear antenna element 50 operates as a monopole antenna, and the second resonance at the frequency 2 occurs in an LC resonance mode due to a capacitor component and an inductance component. The capacitor component is set up by the capacitor 62, and the inductance component is set up when the base portion of the linear antenna element 50 and the linear branch element 52 serve as an inductor. Similar to the antenna device 10, the first and second resonances in the antenna device 60 also occur in the respectively different modes, so that the first and second resonances do not interfere. Thus, it is possible to achieve satisfactory VSWR characteristics.

FIG. 9B indicates the VSWR of the antenna device 60. As indicated in FIG. 9B, the VSWR of the antenna device 60 in the resonance at the frequency 2 is three or smaller, and the width of the bottom range in which the VSWR of the antenna device 60 in the resonance around the frequency 1 is at the bottom level is greater than the width of the bottom range in which the VSWR of the conventional antenna device 100 in the resonance around the frequency 1 indicated in FIG. 12 is at the bottom level. The bottom range is, for example, the range in which the VSWR is three or smaller. In addition, while the VSWR of the conventional antenna device 100 indicated in FIG. 12 is greater than 11 in the range between the frequencies 1 and 2, the VSWR of the antenna device 60 indicated in FIG. 9B is smaller than seven in the range between the frequencies 1 and 2. That is, the interference of the resonances in the antenna device 60 is weak, so that the antenna device 60 performs satisfactory characteristics as indicated in FIG. 9B.

### Fifth Embodiment

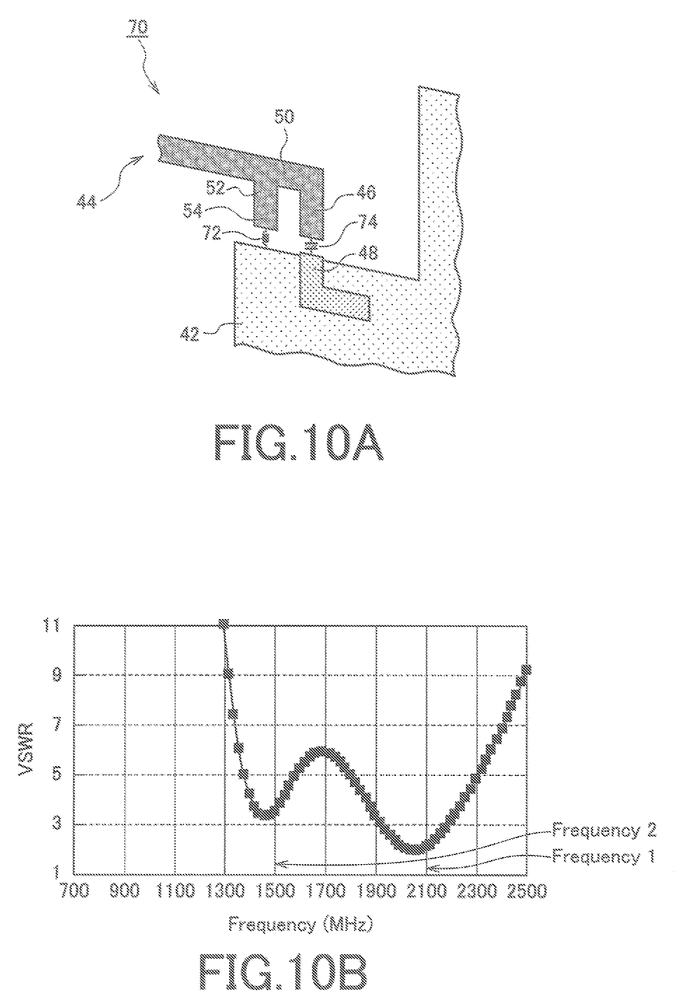

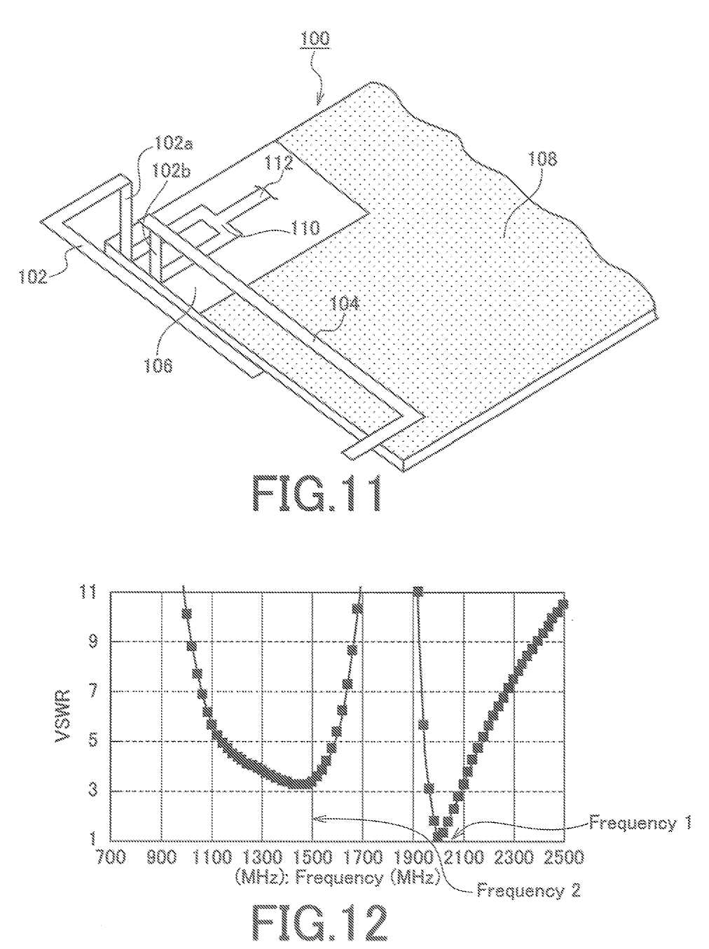

FIG. 10A illustrates the antenna device 70 according to the fifth embodiment. Similar to the antenna body 32 illustrated in FIG. 3, the antenna body 44 in the antenna device 70 includes a linear antenna element 50 and a linear branch element 52. The linear antenna element 50 operates as a monopole antenna, and the linear branch element 52 branches off from the linear antenna element 50 at an intermediate position of the linear antenna element 50. An end 54 of the linear branch element 52 is connected to a ground conductor 42 through an inductor 72.

The antenna device 70 is different from the antenna device 40 illustrated in FIG. 7C in the following points. That is, the antenna device 70 is provided with a capacitor 74 between the first and the second feed terminals 46 and 48 which face each other in the antenna device 70, while a portion of the dielectric substrate is sandwiched between the first and the second feed terminals 46 and 48 in the antenna device 40. In addition, the antenna device 70 is provided with the inductor 72 between the ground conductor 42 and the end of the linear branch element 52 in the antenna device 70 as mentioned above.

In the antenna device 70, similar to the antenna device 10, a first resonance at the frequency 1 occurs in the linear antenna element 50 which operates as a monopole antenna. In addition, a second resonance at the frequency 2 is caused by the capacitor 74, the inductor 72, and the structure constituted by a base portion of the linear antenna element 50 and the linear branch element 52. At this time, the first resonance at the frequency 1 occurs in a mode in which the linear antenna element 50 operates as a monopole antenna, and the second resonance at the frequency 2 occurs in an LC resonance mode due to a capacitor component and inductance components. The capacitor component is set up by the capacitor 74, the first inductance component is set up by the inductor 72 and the structure of the base portion of the linear antenna element 50 and the linear branch element 52. Similar to the antenna device 10, the first and second resonances in the antenna device 70 also occur in the respectively different modes, so that the first and second resonances do not interfere. Thus, it is possible to achieve satisfactory VSWR characteristics. Further, the second inductance component of the inductor 72 can be adjusted according to the target frequency 2.

FIG. 10B indicates the VSWR of the antenna device 70. As indicated in FIG. 10B, the width of the bottom range in which the VSWR of the antenna device 70 in the resonance around the frequency 1 is at the bottom level is greater than the width of the bottom range in which the VSWR of the conventional antenna device 100 in the resonance around the frequency 1 indicated in FIG. 12 is at the bottom level. The bottom range is, for example, the range in which the VSWR is three or smaller. In addition, while the VSWR of the conventional antenna device 100 indicated in FIG. 12 is greater than 11 in the range between the frequencies 1 and 2, the VSWR of the antenna device 70 indicated in FIG. 10B is smaller than seven in the range between the frequencies 1 and 2. That is, the interference of the resonances is weak in the antenna device 70, and the antenna device 70 performs satisfactory characteristics as indicated in FIG. 10B.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An antenna device comprising:
a linear antenna element;
a feeding portion comprising a first feed terminal and a second feed terminal which are arranged apart face-to-face, where the first feed terminal is connected to an end of the linear antenna element, and the second feed terminal is connected to a power supply unit;
a linear branch element which branches off from the linear antenna element at an intermediate position of the linear antenna element; and
a ground conductor which is connected to an end of the linear branch element.

2. The antenna device according to claim 1, wherein the feeding portion is arranged in a dielectric substrate, and a part of a layer of the dielectric substrate is sandwiched by the first feed terminal and the second feed terminal.

3. The antenna device according to claim 2, wherein the first feed terminal is arranged on a surface layer in the dielectric substrate, the second feed terminal is arranged on an inner layer in the dielectric substrate, and a path line connecting the power supply unit and the second feed terminal includes a via conductor which passes through the surface layer in the dielectric substrate.

4. The antenna device according to claim 2, wherein the linear branch element extends parallel to a base portion of the linear antenna element which extends from the end of the linear antenna element to the intermediate position, and the base portion of the linear antenna element and the linear branch element form one of a U-shaped current path and a looped current path.

5. An antenna device comprising:
a linear antenna element;
a feeding portion comprising a capacitor which connects an end of the linear antenna element and a connection line connected to a power supply unit;
a linear branch element which branches off from the linear antenna element at an intermediate position of the linear antenna element; and
a ground conductor which is connected to an end of the linear branch element.

6. The antenna device according to claim 5, wherein an inductor is arranged in a portion of the linear branch element.

7. A wireless communication device comprising:
an antenna device comprising,
a linear antenna element,
a feeding portion comprising a first feed terminal and a second feed terminal which are arranged apart face-to-face, where the first feed terminal is connected to an end of the linear antenna element, and the second feed terminal is connected to a power supply unit,
a linear branch element which branches off from the linear antenna element at an intermediate position of the linear antenna element, and
a ground conductor which is connected to an end of the linear branch element; and
a communication unit which performs at least one of generation of waves to be transmitted in a plurality of frequency bands and detection of a plurality of frequency bands.
